(19) United States
(12) Patent Application Publication
(10) Pub. No.: US 2026/0203676 A1
(43) Pub. Date: Jul. 16, 2026

(54) INFORMATION PROCESSING APPARATUS, INFORMATION PROCESSING METHOD, AND COMPUTER-READABLE STORAGE MEDIUM

(71) Applicant: HONDA MOTOR CO.,LTD., Tokyo (JP)

(72) Inventors: Yoshiya NAKAGAWA, Tokyo (JP); Tatsuya IDE, Tokyo (JP)

(21) Appl. No.: 19/422,371

(22) Filed: Dec. 16, 2025

(30) Foreign Application Priority Data
Jan. 16, 2025 (JP) 2025-006490

(51) Int. Cl. G06Q 10/02; G06Q 50/06; G06Q 50/40

(52) U.S. Cl. CPC G06Q 10/02; G06Q 50/06; G06Q 50/40

(57) ABSTRACT

An information processing apparatus performs information processing for a usage plan of a reservation target. The information processing apparatus includes: a first acquisition unit which acquires first information which includes a first time period for which a reservation target is scheduled to be used for a first use application; a second acquisition unit which acquires second information which includes a second time period for which a reservation target is scheduled to be used for a second use application; a decision unit which decides the usage plan based on the first information and the second information; and a presentation control unit which, in a first time frame, restricts a presentation unit which presents information on the usage plan from presenting identification information that is a portion of the usage plan, and, in a second time frame after the first time frame, allows the presentation unit to present the identification information.

The contents of the following patent application(s) are incorporated herein by reference: NO. 2025-006490 filed in JP on January 16, 2025.

### BACKGROUND

### Technical Field

The present invention relates to an information processing apparatus, an information processing method, and a computer-readable storage medium.

### Related Art

Patent document 1 discloses a technique to use electric power accumulated in a battery of a vehicle, outside the vehicle.

### RELATED ART DOCUMENTS

### Patent Documents

Patent Document 1: International Publication No. 2024/070109

### BRIEF DESCRIPTION OF THE DRAWINGS

FIG. 1 conceptually illustrates a utilization form of a system 5 in an embodiment.

FIG. 2 illustrates an example of a system configuration of a vehicle management apparatus 60.

FIG. 3 illustrates an example of a system configuration of an integrated management apparatus 50.

FIG. 4 illustrates an execution sequence of processing in a method performed by a power control apparatus 40, the integrated management apparatus 50, and the vehicle management apparatus 60.

FIG. 5 schematically illustrates an overview of processing that the vehicle management apparatus 60, the integrated management apparatus 50, and the power control apparatus 40 perform.

FIG. 6 illustrates a screen 600 that provides a user interface provided to the user 20.

FIG. 7 illustrates a data structure of operation plan information indicating an operation plan decided by the vehicle management apparatus 60 based on reservation information.

FIG. 8 schematically illustrates a timetable for using the vehicle 10 for a first use application, in which the operation plan information shown in FIG. 7 is visualized.

FIG. 9 illustrates a screen 900 that provides a user interface provided to the user 20.

FIG. 10 illustrates a screen 1000 that provides a user interface provided to the user 20.

FIG. 11 illustrates a screen 1100 that provides a user interface provided to the user 20.

FIG. 12 illustrates a flowchart for processing to decide a usage plan of the vehicle 10, which is executed by the system 5.

FIG. 13 illustrates a flowchart for processing to present the usage plan of the vehicle 10 to the user 20, which is executed by the system 5.

FIG. 14 illustrates an example of a computer 2000 in which a plurality of embodiments of the present invention may be entirely or partially embodied.

### DESCRIPTION OF EXEMPLARY EMBODIMENTS

Hereinafter, the present invention will be described through embodiments of the invention, but the following embodiments do not limit the invention according to the claims. In addition, not all of the combinations of features described in the embodiments are essential to the solutions of the invention.

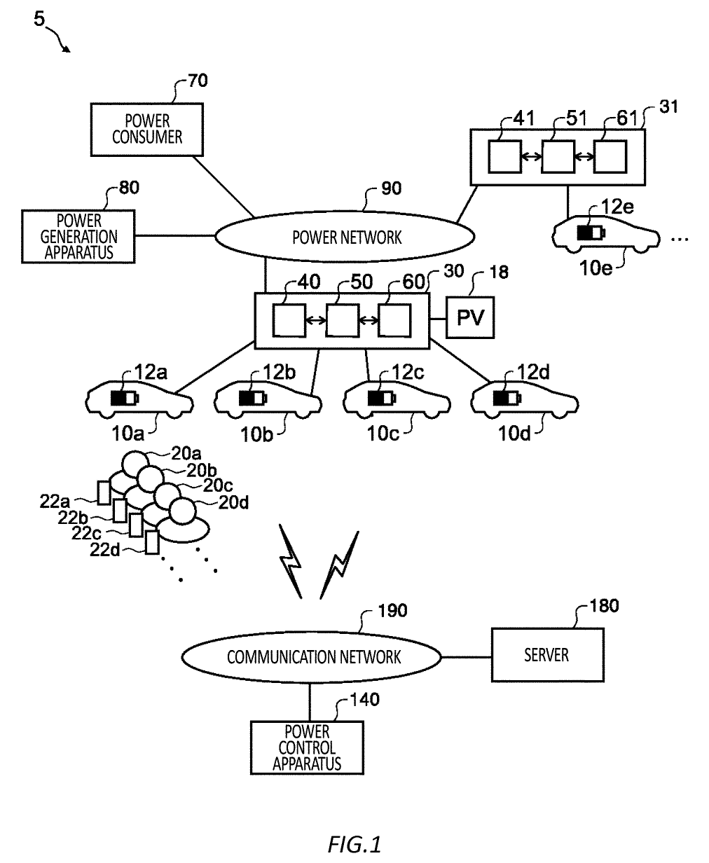

FIG. 1 conceptually illustrates a utilization form of a system 5 in an embodiment. The system 5 includes: a power generation apparatus 80; a plurality of vehicles including a vehicle 10a, a vehicle 10b, a vehicle 10c, a vehicle 10d and a vehicle 10e; a plurality of terminals including a terminal 22a, a terminal 22b, a terminal 22c and a terminal 22d; a power control apparatus 40 and a power control apparatus 41; an integrated management apparatus 50 and an integrated management apparatus 51; a vehicle management apparatus 60 and a vehicle management apparatus 61; a power control apparatus 140; and a server 180.

A power consumer 70 and the power generation apparatus 80 are connected to a power network 90. The electric power generated by the power generation apparatus 80 can be supplied to the power consumer 70 through the power network 90. The power network 90 is a power system, for example.

The vehicle 10a, the vehicle 10b, the vehicle 10c, the vehicle 10d, and the vehicle 10e are electric vehicles that respectively include a battery 12a, a battery 12b, a battery 12c, a battery 12d, and a battery 12e, in which driving electric power for the vehicle to drive is accumulated. The electric vehicle is an example of an electrically-driven vehicle. The electric vehicle is an example of a movable body. In the present embodiment, in particular, the vehicle 10a, the vehicle 10b, the vehicle 10c, and the vehicle 10d may be collectively referred to as a "vehicle 10", and the battery 12a, the battery 12b, the battery 12c, and the battery 12d may be collectively referred to as a "battery 12". The battery 12 is an example of an "energy accumulation apparatus".

The terminal 22a is a terminal that a user 20a uses; and the terminal 22b is a terminal that a user 20b uses; and the terminal 22c is a terminal that a user 20c uses; and the terminal 22d is a terminal that a user 20d uses. In the present embodiment, the terminal 22a, the terminal 22b, the terminal 22c, and the terminal 22d may be collectively referred to as a "terminal 22". The user 20a, the user 20b, the user 20c, and the user 20d may be collectively referred to as a "user 20". The user 20 is a user of the vehicle 10. The user 20 makes a usage reservation of the vehicle 10 by using the terminal 22 and performs confirmation of a status of the usage reservation of the vehicle 10 by using the terminal 22. The vehicle 10 is an example of a "reservation target".

The vehicle 10 is deployed in an office 30. The office 30 functions as a home point for parking the vehicle 10. In the present embodiment, the office 30 may be referred to as "headquarters". The vehicle 10 may be, for example, a vehicle for commercial use or may be a vehicle for carrying shipments such as products handled by the office 30. Electric power is supplied to the office 30 through the power network 90.

The power control apparatus 40, the integrated management apparatus 50, and the vehicle management apparatus 60 are provided in the office 30. The vehicle 10 is provided to be able to communicate with the vehicle management apparatus 60 through a mobile communication network or the like. The office 30 has a local power network in the office, and electric power exchange with the battery 12 included in the vehicle 10 can be performed through a charge-and-discharge apparatus provided in the office 30 and the power network in the office 30. That is, the vehicle 10 can be used for energy management in the office 30. The battery 12 included in the vehicle 10 can perform the electric power exchange with the power network 90 through a power network in the office 30. The power control apparatus 40 controls charging and discharging of the vehicle 10 deployed in the office 30 so as to at least satisfy a power demand in the office 30. The power network 90 and the power network in the office 30 are examples of an energy network.

A power generation apparatus 18 is provided in the office 30. The power generation apparatus 18 generates electric power from renewable energy. Specifically, the power generation apparatus 18 generates electric power from natural energy. Examples of natural energy may include energy obtained from natural phenomena, such as solar, geothermal, wind, and tidal flow. The power generation apparatus 18 generates electric power from at least one of solar light, wind, solar heat, ambient heat, or other heat existing in nature, and tidal flow. The electric power generated by the power generation apparatus 18 is, through the power network in the office 30, supplied to and consumed by an electrical load in the office 30, which is a power consumer. The electric power generated by the power generation apparatus 18 can be used to charge the battery 12 included in the vehicle 10 through the power network in the office 30 and the charge-and-discharge apparatus provided in the office 30. The electric power generated by the power generation apparatus 18 can be used for performing electric power exchange with the power network 90 through the power network in the office 30.

The power control apparatus 40, the integrated management apparatus 50, and the vehicle management apparatus 60 are managed, for example, in the office 30. The power control apparatus 40 and the integrated management apparatus 50 are provided to be able to communicate with each other through a communication line. The integrated management apparatus 50 and the vehicle management apparatus 60 are provided to be able to communicate with each other through a communication line. The integrated management apparatus 50 and the vehicle management apparatus 60 may be provided outside the office 30. The integrated management apparatus 50 and the vehicle management apparatus 60 may be provided to be able to communicate with each other through a communication line such as the Internet. One or both of the integrated management apparatus 50 and the vehicle management apparatus 60 may be embodied as a server, such as a cloud server.

The user 20 makes a usage reservation of the vehicle 10 by using the terminal 22. For example, the user 20 inputs a time of departure from the office 30, a destination, and a time of return to the office 30, into the terminal 22. The terminal 22 transmits reservation information to the vehicle management apparatus 60 through a communication network 190.

The vehicle management apparatus 60 decides a time of departure and a time of return of the vehicle 10 from/to the office 30 based on the reservation information received from the terminal 22. The integrated management apparatus 50 performs arbitration for adjusting the time of departure and the time of return of the vehicle 10 from/to the office 30 so as to meet a power demand in the office 30. For example, the integrated management apparatus 50 performs arbitration for adjusting the time of departure and the time of return of the vehicle 10 from/to the office 30 so that peak shaving of the power demand in the office 30 can be performed. The vehicle management apparatus 60 manages the vehicle 10 based on the schedule of the vehicle 10 adjusted by the integrated management apparatus 50. The power control apparatus 40 controls charging and discharging of the battery 12 included in the vehicle 10 based on the schedule of the vehicle 10 adjusted by the integrated management apparatus 50.

The vehicle 10e is deployed in an office 31. The office 31 functions as a home point for parking the vehicle 10e. Similar to the vehicle 10, the vehicle 10e may be a vehicle for commercial use or may be a vehicle for carrying shipments such as products handled by the office 31. Electric power is supplied to the office 31 through the power network 90. The power control apparatus 41, the integrated management apparatus 51, and the vehicle management apparatus 61 are provided in the office 31.

In the office 31, the power control apparatus 41, the integrated management apparatus 51, and the vehicle management apparatus 61 correspond to the power control apparatus 40, the integrated management apparatus 50, and the vehicle management apparatus 60. The power control apparatus 41, the integrated management apparatus 51, and the vehicle management apparatus 61 perform control similar to that of the power control apparatus 40, the integrated management apparatus 50, and the vehicle management apparatus 60 except that a control target and/or a management target is the office 31 and/or the vehicle 10e. For this reason, the description of the control related to the power control apparatus 41, the integrated management apparatus 51, the vehicle management apparatus 61, and the vehicle 10e is omitted.

The power control apparatus 140 communicates with the power control apparatus 40 and the power control apparatus 41 through a communication network 190, and supervises overall power control in the office 30 and the office 31. For example, the power control apparatus 140 collects information related to power supply and demand from the power control apparatus 40 and the power control apparatus 41, and performs adjustment of overall power supply and demand including electricity transaction with the power network 90, so that the power control apparatus 40 and the power control apparatus 41 are caused to perform control so as to minimize the total electricity cost of the office 30 and the office 31.

The power control apparatus 140 is connected to the server 180 through the communication network 190. The server 180 is, for example, a server used by a power aggregator. The server 180 conducts electricity transactions in an electricity market. The power control apparatus 140 can provide the server 180 with power resources that are held by aggregating the vehicles deployed in the office 30 and the office 31. The power control apparatuses 40 and 41 control charging and discharging of the battery of each of the vehicles deployed in the office 30 and the office 31, and the power control apparatus 140 provides electric power agreed by the server 180. For example, according to the demand from the server 180, the power control apparatus 140 controls charging and discharging of the battery 12 by the power control apparatus 40 and the power control apparatus 41, and provides electric power corresponding to the demand.

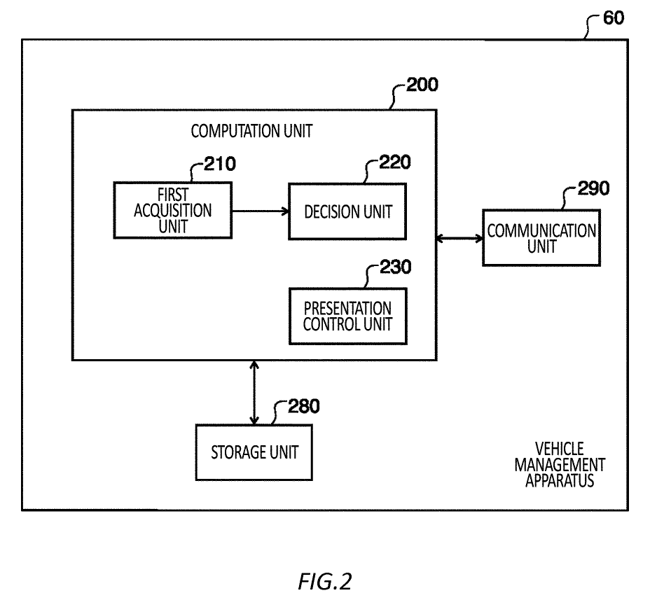

The control mainly related to the office 30 will be described with reference to FIG. 2 to FIG. 13 etc. Specifically, control related to the power control apparatus 40, the integrated management apparatus 50, the vehicle management apparatus 60, and the vehicle 10 is described. However, the control related to the office 30 can be applied to the control related to the office 31.

FIG. 2 illustrates an example of a system configuration of the vehicle management apparatus 60. The vehicle management apparatus 60 includes a computation unit 200, a storage unit 280, and a communication unit 290. The vehicle management apparatus 60 performs information processing for a usage plan of the vehicle 10. The vehicle management apparatus 60 functions as at least a part of an information processing apparatus that performs information processing for the usage plan of the vehicle 10.

The computation unit 200 performs control of the communication unit 290. The communication unit 290 is responsible for communication between the vehicle 10, the integrated management apparatus 50, and the terminal 22, for example. The computation unit 200 is embodied as an arithmetic processing unit including a processor. Each storage unit 280 is embodied to include a non-volatile storage medium. The computation unit 200 performs processing by using the information stored in the storage unit 280. The computation unit 200 may be embodied as a microcomputer including a CPU, a ROM, a RAM, an I/O, a bus, and the like. The vehicle management apparatus 60 may be embodied as a computer.

In the present embodiment, the vehicle management apparatus 60 shall be embodied as a single computer. However, in another embodiment, the vehicle management apparatus 60 may be embodied as a plurality of computers. At least some of functions of the vehicle management apparatus 60 may be implemented by one or more servers, such as a cloud server.

The computation unit 200 includes a first acquisition unit 210, a decision unit 220, and a presentation control unit 230. The first acquisition unit 210 acquires reservation information on a reservation of the vehicle 10. For example, the first acquisition unit 210 acquires the reservation information transmitted by the terminal 22. The storage unit 280 stores the reservation information. The decision unit 220 acquires the reservation information from the storage unit 280, and devises the usage plan of the vehicle 10 based on the reservation information thus acquired.

The reservation information includes first information that includes a first time period for which the vehicle 10 is scheduled to be used for a first use application. In the present embodiment, the first use application is a use application that involves traveling of the vehicle 10. Specifically, the first use application is a use application that involves driving of the vehicle 10. The first use application is a use application which involves driving of the vehicle 10 with the user 20 seated in it. The first time period may include a time to start using the vehicle 10 and a time to finish using the vehicle 10. The first time period may include a duration to use the vehicle 10.

The decision unit 220 devises a usage plan of the vehicle 10 based on the first information. The usage plan includes the first information, which includes the first time period decided by the decision unit 220. The decision unit 220 transmits the usage plan thus devised to the integrated management apparatus 50 through the communication unit 290. The decision unit 220 receives a result of arbitration of the usage plan by the integrated management apparatus 50, and decides a usage plan of the vehicle 10 based on the result of arbitration thus received. The presentation control unit 230, in a first time frame, restricts the terminal 22 that presents information on the usage plan of the vehicle 10 from presenting identification information that is a portion of the usage plan, and, in a second time frame after the first time frame, allows the terminal 22 to present the identification information. For example, the first time frame is a time frame for which the integrated management apparatus 50 performs arbitration of the usage plan.

The first information may further include designation information for designating a specific vehicle 10 which is to be used for the first use application, among the plurality of vehicles 10. The first information may further include information on a degree of importance of the designation information. The first information may further include information on a degree of importance of the first time period. The identification information may include information for identifying the vehicle 10 which is to be used for the first use application in the usage plan of the vehicle 10.

The identification information may include information for identifying a time at or a time frame for which the vehicle 10 is to be used for the first use application in the usage plan of the vehicle 10.

The presentation control unit 230, in the first time frame, allows a presentation unit to present a time at or a time frame for which the vehicle 10 is to be used for the first use application in the usage plan. The presentation control unit 230, in the first time frame, allows the presentation unit to present information for identifying the vehicle 10 which is to be used for the first use application in the usage plan.

The communication unit 290 transmits the operation plan to the integrated management apparatus 50. The communication unit 290 may further transmit at least a part of the reservation information to the integrated management apparatus 50. The communication unit 290, when the vehicle 10 which is to be used by the user is changed due to arbitration of competing reservations, may transmit a notification indicating that the vehicle 10 is changed, to the user for whom the vehicle 10 thus changed was reserved.

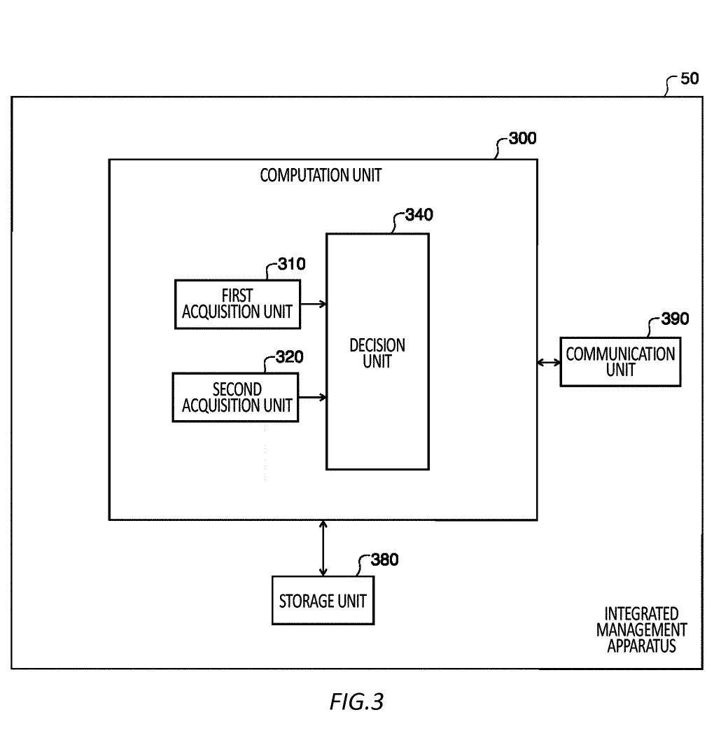

FIG. 3 illustrates an example of a system configuration of the integrated management apparatus 50. The integrated management apparatus 50 includes a computation unit 300, a storage unit 380, and a communication unit 390. The integrated management apparatus 50 performs information processing for the usage plan of the vehicle 10. The integrated management apparatus 50 functions as at least a part of an information processing apparatus that performs information processing for the usage plan of the vehicle 10.

The computation unit 300 performs control of the communication unit 390. The communication unit 390 is responsible for communication in the integrated management apparatus 50. The communication unit 390 is responsible for communication between at least the power control apparatus 140, the vehicle management apparatus 60, and the power control apparatus 40 and the integrated management apparatus 50. The computation unit 300 is embodied as an arithmetic processing unit including a processor. Each storage unit 380 is embodied to include a non-volatile storage medium. The computation unit 300 performs processing by using the information stored in the storage unit 380. The computation unit 300 may be embodied as a microcomputer including a CPU, a ROM, a RAM, an I/O, a bus, and the like. The integrated management apparatus 50 may be embodied as a computer.

In the present embodiment, the integrated management apparatus 50 shall be embodied to include a single computer. However, in another embodiment, the integrated management apparatus 50 may be implemented by a plurality of computers. At least some of functions of the integrated management apparatus 50 may be embodied to include one or more servers, such as a cloud server. In the present embodiment, the integrated management apparatus 50 and the vehicle management apparatus 60 may be embodied as a same computer or may be embodied as computers different from each other. All or at least some of the functions of the integrated management apparatus 50 and the vehicle management apparatus 60 may be implemented by the same computer.

The computation unit 300 includes a first acquisition unit 310, a second acquisition unit 320, and a decision unit 340.

The first acquisition unit 310 acquires the first information that includes the first time period for which the vehicle 10 is scheduled to be used for the first use application. For example, the first acquisition unit 310 acquires information indicating the usage plan that includes the first information decided by the vehicle management apparatus 60, which is transmitted by the vehicle management apparatus 60. The storage unit 380 stores information indicating the usage plan thus acquired.

The second acquisition unit 320 acquires second information that includes a second time period for which the vehicle 10 is scheduled to be used for a second use application. For example, the second use application is a use application for which the vehicle 10 is to be used for energy exchange between the vehicle 10 and a power network that is capable of energy exchange.

Specifically, the second acquisition unit 320 acquires, as the second information, energy request information on a request for energy that is to be provided by the vehicle 10. For example, the second acquisition unit 320 accepts the energy request information from the power control apparatus 40. The energy request information may include information indicating the second time period for which energy is requested. The energy request information may further include information indicating an amount of energy that is to be provided from the vehicle 10.

The decision unit 340 decides a usage plan based on the first information acquired by the first acquisition unit 310 and the second information acquired by the second acquisition unit 320. The decision unit 340 decides a time period for which the vehicle 10 is to be used for the first use application and a time period for which the vehicle 10 is to be used for the second use application based on the first information and the second information. For example, the decision unit 340 may decide the time period for which the vehicle 10 is to be used for the first use application and the time period for which the vehicle 10 is to be used for the second use application, by regarding a time period for which the vehicle 10 is not to be used for the first use application as a time period for which the vehicle 10 is able to be used for the second use application. When the time period for which the vehicle 10 is to be used for the first use application and the time period for which the vehicle 10 is to be used for the second use application cannot be decided by regarding the time period for which the vehicle 10 is not to be used for the first use application as the time period for which the vehicle 10 is able to be used for the second use application, the decision unit 340 performs arbitration of the first use application and the second use application. For example, the decision unit 340 decides an adjustment amount of the time period to be used for the first use application, and/or an adjustment amount of the time period to be used for the second use application, and transmits a result of the arbitration indicating the adjustment amounts thus decided to the vehicle management apparatus 60 and the power control apparatus 40.

In the present embodiment, the description will focus on "electric power" as an example of "energy". In the present embodiment, electric power exchange is an example of "energy exchange". However, energy is not limited only to electric power. As an example, an embodiment that uses fuel such as hydrogen as an energy source, as a form of "energy", can be employed.

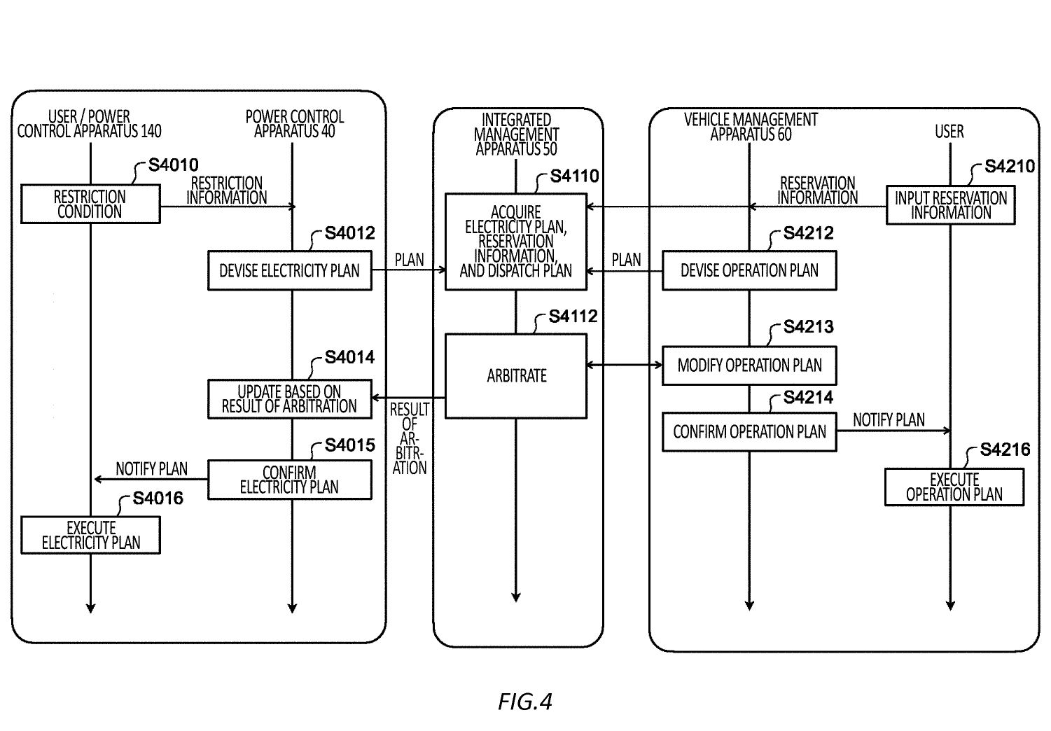

FIG. 4 illustrates an execution sequence of processing in a method performed by the power control apparatus 40, the integrated management apparatus 50, and the vehicle management apparatus 60. The processing of FIG. 4 represents processing from devising of an electricity plan and an operation plan on a particular date until various types of control are performed according to the plans thus devised. The devising of the electricity plan and the operation plan is performed on a day before the target particular date or at a relatively early time on the particular date.

As control for the power control apparatus 40, in S4010, at least one of a user of the power control apparatus 40 or the power control apparatus 140 sets a restriction condition on the electricity plan in the office 30 to notify the power control apparatus 40 thereof. The power control apparatus 140 may set the restriction condition in the office 30 so as to minimize the overall electricity cost in the office 31 and the office 30. The user is a person or a system that inputs information on power management into the power control apparatus 40 in the office 30. The restriction condition is a condition which becomes a restriction for devising of the electricity plan. The restriction condition may include a restriction that is required to meet the power demand. The restriction condition includes a predicted amount of electric power to be generated, a predicted power consumption, and information on electricity charge, for example. The amount of electric power to be generated is an amount of electric power to be generated by the power generation apparatus 80, for example. The power consumption is a power consumption in the office 30. The electricity charge includes an electricity purchase price, an electricity selling price, and a monetary consideration obtained by reducing the power consumption according to a demand response. The electricity purchase price is, for example, a condition related to an amount of money charged as a monetary consideration for power reception by the office 30 from the power network 90. The electricity selling price is, for example, a condition related to an amount of money obtained as a monetary consideration for power supply by the office 30 to the power network 90.

In S4012, the power control apparatus 40 devises an electricity plan for a target date in the office 30 based on restriction information. The electricity plan includes a power consumption for each time frame in one day. The electricity plan defines how much electric power is consumed for each time frame in the office 30. The power consumption for each time frame on the target date may be predicted from environmental information, such as weather information on the target date, and data of past performance. The electricity plan may include peak-shaving information for performing peak shaving. The peak-shaving information may include information indicating how much power consumption is to be suppressed during what time frame in the office 30. The peak-shaving information may include information indicating how much electric power is to be received from the outside during what time frame in the office 30. The electricity plan may include power discharge information indicating how much electric power is discharged to the outside from the office 30. The power discharge information may include information indicating how much electric power is to be discharged to the outside from the office 30 in which time frame. For example, when an amount of electric power to be generated by the power generation apparatus 18 is predicted to falls below the power consumption of the office 30, the electricity plan may include power discharge information which includes information indicating an extra amount of electric power for each time frame obtained by subtracting the power consumption of the office 30 from the amount of electric power to be generated by the power generation apparatus 18.

The power control apparatus 40 may devise an optimal electricity plan in the office 30. For example, the power control apparatus 40 may devise an electricity plan so as to minimize the amount of electric power received from the power network 90 in the office 30. The power control apparatus 40 may devise an electricity plan so as to minimize the amount of money charged as a monetary consideration for power reception from the power network 90 received in the office 30. On condition that the contracted power in at least the office 30 is complied with, the power control apparatus 40 may devise an electricity plan so as to maximize an amount of money obtained as a monetary consideration for reducing the power consumption in the office 30 according to the demand response in the office 30 or performing power supply to the power network 90. In this manner, the power control apparatus 40 devises the optimal electricity plan as the electricity plan on the target date in the office 30 based on the restriction condition. This electricity plan defines an amount of electric power that needs to be received from the outside for each time frame on the target date and/or an amount of electric power that needs to be discharged to the outside. The amount of electric power that needs to be received from the outside may be supplied from the battery 12 included in the vehicle 10 parked in the office 30. The amount of electric power that needs to be discharged to the outside may be supplied to the battery 12 included in the vehicle 10 parked in the office 30. The power control apparatus 40 transmits the electricity plan thus devised to the integrated management apparatus 50.

As control for the vehicle management apparatus 60, in S4210, the user inputs reservation information on dispatch of the vehicle 10. The user is a person who uses the vehicle 10, a manager of the system, the system, or the like. The reservation information includes a condition that may become a restriction on devising of the operation plan. The reservation information includes a departure point, a destination, and a return point, and a departure time at the departure point, a return time and a departure time at the destination, and a return time to the return point, and so on, for example. The departure point and the destination define from which location to which location the vehicle 10 needs to drive. For the departure time at the departure point and the return time at the return point, a duration adjustment allowance may be set, which indicates a duration for which a change of departure time and return time can be allowed to be made. The reservation information input in S4210 is transmitted to the vehicle management apparatus 60 and also transmitted to the integrated management apparatus 50 through the vehicle management apparatus 60.

In S4212, the decision unit 220 of the vehicle management apparatus 60 devises an operation plan on the target date in the office 30 by aggregating the restriction conditions which has been notified of by the user 20. For example, the decision unit 220 decides the vehicle 10 which is to be used for transporting a person, a drive route of the vehicle 10, and a drive speed of the vehicle 10, so as to satisfy a transportation demand defined by the reservation information. The vehicle management apparatus 60 transmits the operation plan thus devised to the integrated management apparatus 50.

In S4110, the integrated management apparatus 50 accepts the electricity plan transmitted from the power control apparatus 40 as well as the reservation information and the operation plan transmitted from the vehicle management apparatus 60.

In S4112, the decision unit 340 of the integrated management apparatus 50 determines whether or not the electricity plan in the office 30 is satisfied if the vehicle 10 is operated according to the operation plan. For example, the operation plan defines a time period for which it is predicted that the vehicle 10 will exist in the office 30. The decision unit 340 determines that the electricity plan is satisfied if it is predicted that, in a time period for which the office 30 needs power supply from the outside, electric power can be received from the battery 12 included in the vehicle 10 existing at the office 30 for the time period in question.

When it is determined that the electricity plan cannot be satisfied if the vehicle 10 is dispatched according to the operation plan, the decision unit 340 determines how the operation plan should be modified so that the electricity plan can be satisfied. For example, the decision unit 340 decides an adjustment amount of the departure time and the return time of the vehicle 10 in the operation plan as a result of arbitration. The decision unit 340 may decide information that the vehicle 10 to be used by the user 20 defined by the operation plan is to be changed as the result of arbitration. The result of arbitration may include information indicating a time period for which the vehicle 10 is to be used to perform peak shaving in the office 30. The result of arbitration may include information indicating a time period for which the vehicle 10 is to be used for discharging extra electric power generated in the office 30 to the outside.

The integrated management apparatus 50 transmits the result of arbitration thus decided to the vehicle management apparatus 60. Upon receiving the result of arbitration from the integrated management apparatus 50, the decision unit 220 of the vehicle management apparatus 60 decides the usage plan of the vehicle 10 by modifying the operation plan devised in S4212 based on the result of arbitration (S4213). For example, the decision unit 220 modifies the operation plan so that the reservation information is satisfied based on the adjustment amount of the departure time and the return time received from the integrated management apparatus 50. The vehicle management apparatus 60 transmits a result of modifying the operation plan to the integrated management apparatus 50. The integrated management apparatus 50 and the vehicle management apparatus 60 repeat the processes in S4112 and S4213 to decide a performable operation plan. In S4213, the decision unit 220 decides the performable operation plan by deciding an operation route of the vehicle 10 and judging whether or not the vehicle 10 can return to the office 30 without running out of charge when causing the vehicle 10 to drive so that the departure time and the return time designated by the reservation information can be complied with, based on an SOC and the power consumption rate of the vehicle 10. Also, in S4112, considering an amount of electricity cost reduced in the office 30 when electric power exchange between the battery 12 and the office 30 according to the electricity plan thus decided is performed, and necessary operational cost of the vehicle 10 and utilization rate of the vehicle 10 when the vehicle 10 is operated according to the operation plan, the decision unit 340 may judge that the operation plan is performable, on condition that it is determined to be profitable in total.

When the operation plan is decided, the result of arbitration including the operation plan is transmitted to the power control apparatus 40. Upon receiving the result of arbitration from the integrated management apparatus 50, the power control apparatus 40 updates the electricity plan based on the result of arbitration (S4014), and notifies the user of the electricity plan confirmed by updating based on the result of arbitration (S4015). In S4016, the user and the power control apparatus 140 execute control according to the electricity plan thus notified of.

The vehicle management apparatus 60 confirms the operation plan finally decided in S4213 (S4214). When receiving a presentation request for the operation plan through the terminal 22 from the user 20, the vehicle management apparatus 60 notifies the user of the operation plan thus confirmed through the communication unit 290. In S4216, the user performs control of operating the vehicle 10 according to the operation plan thus notified of. For aspects of presenting the operation plan, an aspect of presenting in a time frame where the operation plan has been confirmed and an aspect of presenting in a time frame where the operation plan has not been confirmed will be described below.

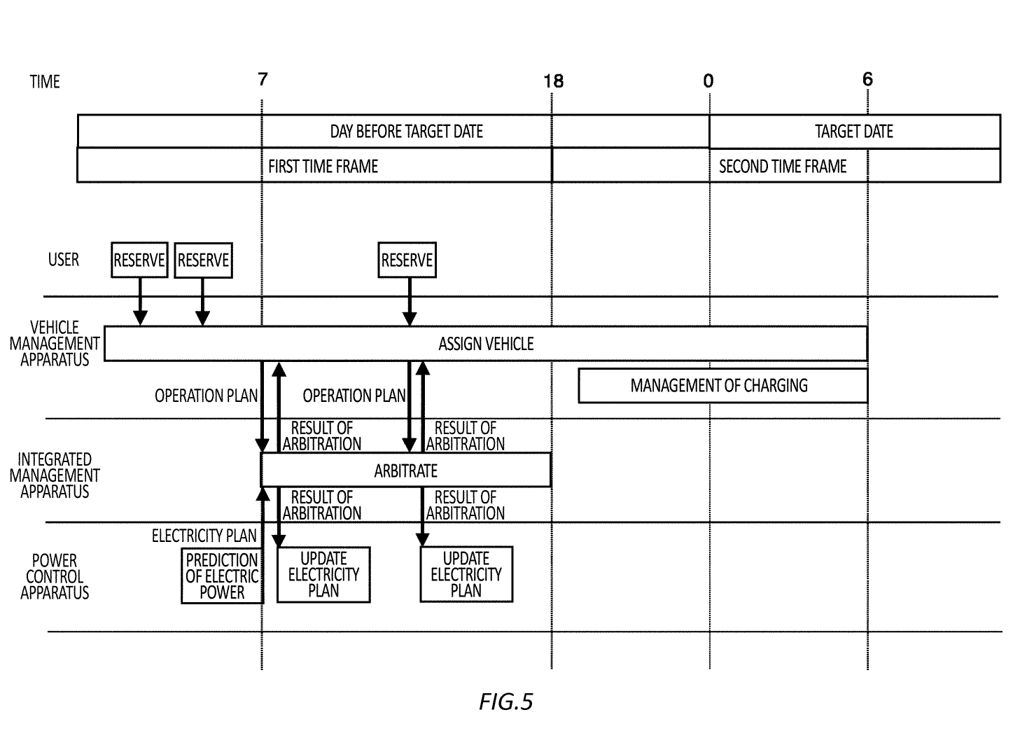

FIG. 5 schematically illustrates an overview of processing that the vehicle management apparatus 60, the integrated management apparatus 50, and the power control apparatus 40 perform. In FIG. 5, the day on which the vehicle 10 is to be used is referred to as a "target date".

The user 20 can make a reservation for the vehicle 10 at any timing prior to a timing to use the vehicle 10. When the user 20 inputs reservation information on the vehicle 10 by using the terminal 22, the terminal 22 transmits the reservation information to the vehicle management apparatus 60. The reservation information includes first information indicating a time period for which the vehicle 10 is to be used to drive.

In the vehicle management apparatus 60, the decision unit 220, upon receiving the reservation information that includes the first information, decides an operation plan of the vehicle 10 by assigning the vehicle 10 to be used by the user 20 based on the reservation information and an operation plan of the vehicle 10 that has been already decided at the time point when the reservation information is received. The vehicle management apparatus 60 transmits, at a predefined first timing, the operation plan that includes the first information, which is decided by the decision unit 220, to the integrated management apparatus 50.

The power control apparatus 40 performs prediction on electric power for the target date. For example, the power control apparatus 40 predicts a power consumption in the office 30 for each time frame on the target date, and an amount of electric power to be generated by the power generation apparatus 18, and decides, based on the amount of electric power thus predicted, a time period for which the vehicle 10 is to provide electric power to the office 30 and an amount of the electric power. The power control apparatus 40 transmits, at the first timing, an electricity plan that includes second information indicating the time period for which the vehicle 10 is to provide electric power to the office 30 and the amount of the electric power, to the integrated management apparatus 50.

Although a case is illustrated where the "first timing" is 7 a.m. on a day before the target date in FIG. 5, the "first timing" is not limited to 7 a.m. on the day before the target date. The "first timing" may be a time other than 7 a.m. on the day before the target date. The "first timing" may be a timing prior to the day before the target date. The "first timing" may be a specific time on the target date.

The integrated management apparatus 50 performs arbitration based on the operation plan received from the vehicle management apparatus 60 and the electricity plan received from the power control apparatus 40, and transmits a result of the arbitration to the vehicle management apparatus 60 and the power control apparatus 40. For a time period from the first timing to a second timing, the integrated management apparatus 50 performs arbitration of the operation plan and the electricity plan every time the user 20 makes a new reservation.

At the second timing, the integrated management apparatus 50 finishes arbitrating, and the operation plan and the electricity plan are confirmed. The vehicle management apparatus 60 performs control of charging the vehicle 10 according to the operation plan thus confirmed. At least one of the vehicle management apparatus 60 or the power control apparatus 40 may cooperate, through the integrated management apparatus 50 for example, to decide information, such as a charge completion time and a goal SOC of the battery 12 that are needed for the electricity plan and the operation plan and to control charging of the vehicle 10 based on the information thus decided.

Although a case is illustrated where the "second timing" is 6 p.m. on the day before the target date in FIG. 5, the "second timing" is not limited to 6 p.m. on the day before the target date. The "second timing" may be a time other than 6 p.m. on the day before the target date. The "second timing" may be a timing prior to the day before the target date. The "second timing" may be a specific time on the target date.

As shown in an example in FIG. 5, in the present embodiment, a time frame prior to the second timing may correspond to the "first time frame". In the present embodiment, a time frame before the vehicle 10 starts being used in a time frame after the second timing may correspond to the "second time frame".

In this manner, "first time frame" includes a time frame prior to a timing at which the second acquisition unit 320 of the integrated management apparatus 50 acquires the electricity plan. That is, the "first time frame" includes a time frame prior to a timing at which the second acquisition unit 320 of the integrated management apparatus 50 acquires the second information, and the "second time frame" includes a time frame after the second acquisition unit 320 acquires the second information. Specifically, the "second time frame" includes a time frame after the second acquisition unit 320 acquires the second information, and after the second timing at which a time period for which the integrated management apparatus 50 arbitrates finishes.

When the vehicle management apparatus 60 receives, from the terminal 22, a confirmation request of a reservation status made by the user 20, the presentation control unit 230 restricts the terminal 22 from presenting identification information that is a portion of the operation plan in the first time frame, while it allows the terminal 22 to present the identification information in question in the second time frame. The "identification information" may be information for identifying the vehicle 10 to be used by the user 20, or may be a time to start and a time to end using the vehicle 10 by the user 20, for example. In this manner, the system 5 allows, in the first time frame for which there is a relatively high chance of changing the operation plan, content of notification to the user 20 to be controlled so that information with which the vehicle 10 to be used by the user 20 can be identified or the like is not presented to the user 20. This can prevent the user 20 from being worried unnecessarily, since even if there is a change of operation plan and therefore the vehicle 10 to be used by the user 20 is changed in the first time frame, the user 20 is not notified of the change. On the other hand, convenience for the user 20 can be improved, since it can be possible for the information with which the vehicle 10 to be used by the user 20 can be identified or the like to be presented to the user 20 in the second time frame for which there is a relatively low chance of the change of the operation plan.

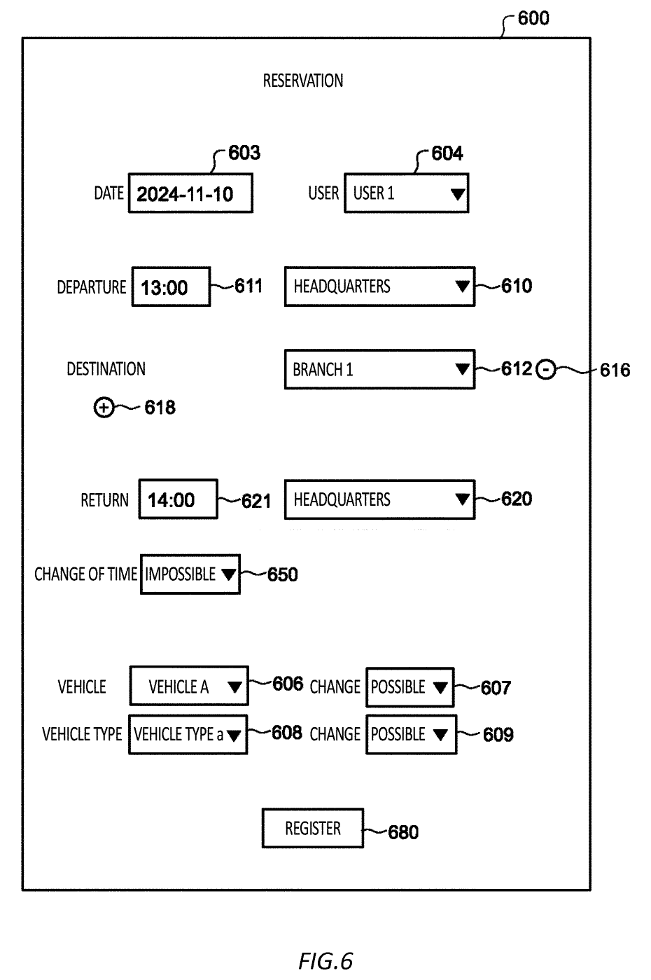

FIG. 6 illustrates a screen 600 that provides a user interface provided to the user 20. The screen 600 is an example of a reservation screen which is provided through the terminal 22 when the user 20 is to input the reservation information on the vehicle 10.

The screen 600 includes an input box 603 for inputting a date to reserve the vehicle 10, and a selection menu 604 for selecting the user of the vehicle 10.

The screen 600 includes a selection menu 610 for selecting a departure point, and an input box 611 for inputting a departure time.

The screen 600 includes a selection menu 612 for selecting a spot that is a destination (waypoint). The screen 600 includes a button 618 for adding a destination and a button 616 for deleting a destination.

The screen 600 includes a selection menu 620 for selecting a return point, and an input box 621 for inputting a return time at which the vehicle 10 arrives at the return point. The return point is a spot at which the user finally arrives using the vehicle 10. That is, it is a spot at which the user finishes using the vehicle 10. The departure time corresponds to the time to start using the vehicle 10, and the return time corresponds to the time to end using the vehicle 10. Information input via the input box 611 and the input box 621 is an example of information indicating the first time period for which the vehicle 10 is scheduled to be used for the first use application.

The screen 600 includes a selection menu 650 for selecting whether or not to allow a change of the time already reserved. In the example of the screen 600, it is selected that a change of time to use the vehicle 10 due to arbitration is not allowed. Information input via the selection menu 650 is an example of the information on the degree of importance of the first time period.

The screen 600 includes a selection menu 606 for selecting the vehicle 10 to be used by the user and a selection menu 607 for selecting whether or not to allow a change of vehicle 10 to be used. The example of the screen 600 shows that the user 20 reserves "vehicle A", and allows a change of vehicle 10 to be used due to arbitration. Information input via the selection menu 606 is an example of designation information to designate a specific vehicle 10. The selection menu 607 becomes available for input when any vehicle is designated via the selection menu 606. Information input via the selection menu 607 is an example of information on the degree of importance of the vehicle 10 to be used.

The screen 600 includes a selection menu 608 for designating a vehicle type of vehicle 10 to be used by the user, and a selection menu 609 for selecting whether or not to allow a change of vehicle type. The example of the screen 600 shows that the user reserves the vehicle 10 of "vehicle type a", and allows a change of vehicle type of vehicle 10 to be used due to arbitration. Information input via the selection menu 609 is an example of information on the degree of importance of the vehicle type of vehicle 10 to be used.

The screen 600 includes a register button 680 for registering the reservation. When the register button 680 is pressed, reservation information that includes the information input on the screen 600 is transmitted to the vehicle management apparatus 60. The decision unit 220 of the vehicle management apparatus 60, upon receiving the reservation information transmitted from the terminal 22, decides an operation plan of the vehicle 10.

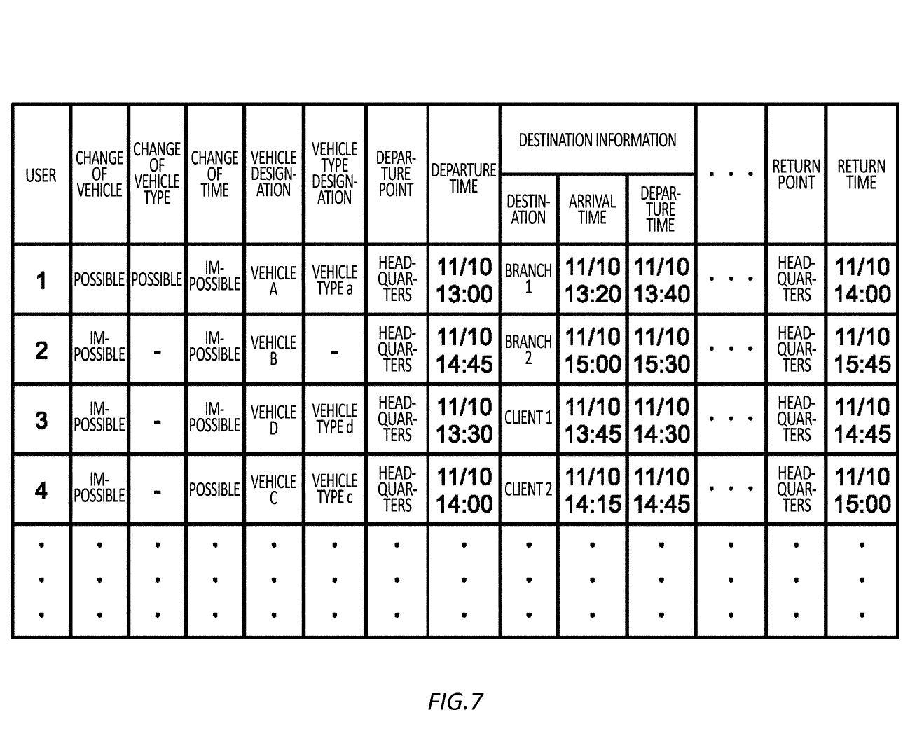

FIG. 7 illustrates a data structure of operation plan information indicating the operation plan decided by the vehicle management apparatus 60 based on the reservation information. The operation plan information is generated based on the reservation information input onto the screen 600, for example.

The operation plan information includes pieces of information individually indicating "user", "change of vehicle", "change of vehicle type", "change of time", "vehicle designation", "vehicle type designation", "departure point", "departure time", "destination information", "return point", and "return time". "Destination information" includes "destination", "arrival time", and "departure time". Although one piece of destination information is specifically shown in FIG. 7, when a plurality of destinations are designated on the screen 600, a plurality of pieces of "destination information" are generated.

Among the pieces of information included in the operation plan information, "vehicle designation", "vehicle type designation", "departure time", and "return time" are examples of conditions to be satisfied by the vehicle 10 that the user can use. "Change of time ", "change of vehicle", and "change of vehicle type" are individual examples of the information indicating the degree of importance of the conditions.

"User" is information for identifying a person who uses the vehicle 10. "Change of time" is information indicating whether or not to allow a change of condition on the first time period. The condition on the first time period includes "departure time" and "return time", which will be described below. "Impossible" in "change of time" indicates that a change of condition on the first time period is not allowed. "Possible" in "change of time" indicates that a change of condition on the first time period is allowed. "Change of time" is an example of information on the degree of importance of the first time period.

"Change of vehicle" is information indicating whether or not to allow a change of condition on the vehicle 10 to be used. The condition on the vehicle 10 to be used is "vehicle designation", which will be described below. "Impossible" in "change of vehicle" indicates that a change of condition on the vehicle 10 to be used is not allowed. "Possible" in "change of vehicle" indicates that a change of condition on the vehicle 10 to be used is allowed. "Change of vehicle" is an example of information indicating the degree of importance of the vehicle 10 to be used.

"Change of vehicle type" is information indicating whether or not to allow a change of condition on the type of vehicle 10 to be used, i.e., vehicle type. The condition on the vehicle type is "vehicle type designation", which will be described below. "Impossible" in "change of vehicle type" indicates that a change of condition on the vehicle type is not allowed. "Possible" in "change of vehicle type" indicates that a change of condition on the vehicle type is allowed. "Change of vehicle type" is an example of information indicating the degree of importance of the vehicle type.

"Vehicle designation" is designated when a specific vehicle 10 is desired to be used. For "vehicle designation", information for identifying the vehicle 10 desired to be used is set.

"Vehicle type designation" is designated when a specific vehicle type of vehicle 10 is desired to be used. For "vehicle type designation", information for identifying the vehicle type is set.

"Departure point" indicates the departure point of the vehicle 10. "Departure time" is a scheduled time at which the vehicle 10 departs from the departure point. "Destination information" includes information on the destination of the vehicle 10. "Destination" of "destination information" indicates a spot of the destination. "Arrival time" of "destination information" indicates a scheduled time to arrive at the spot of the destination. "Departure time" of "destination information" indicates a scheduled time to depart from the spot of the destination. "Arrival time" and "departure time" of "destination information" may be decided by the decision unit 220 of the vehicle management apparatus 60, based on path information from the departure point to the destination, path information between a plurality of different destinations, and/or path information from the destination to the return point.

"Return point" is a spot at which the user finally arrives using the vehicle 10. That is, this is a spot at which the user finishes using the vehicle 10. "Return time" is a scheduled time at which the vehicle 10 arrives at the return point.

For example, according to the example of FIG. 7, a reservation by user 1 is to use "vehicle A", depart from headquarters at 1 p.m., arrive at branch 1 at 1:20 p.m., and then depart from branch 1 at 1:40 p.m., returning to headquarters at 2 p.m. The reservation by user 1 designates that a change of time is not allowed, and a change of vehicle and a change of vehicle type are allowed.

In the integrated management apparatus 50, the decision unit 340, when there are competing reservations, arbitrates the competing reservations based on the operation plan information. For example, the decision unit 340 adjusts competing reservations by adjusting which vehicle 10 is to be used by the user 20 and/or adjusting the departure time and the return time based on the operation plan information.

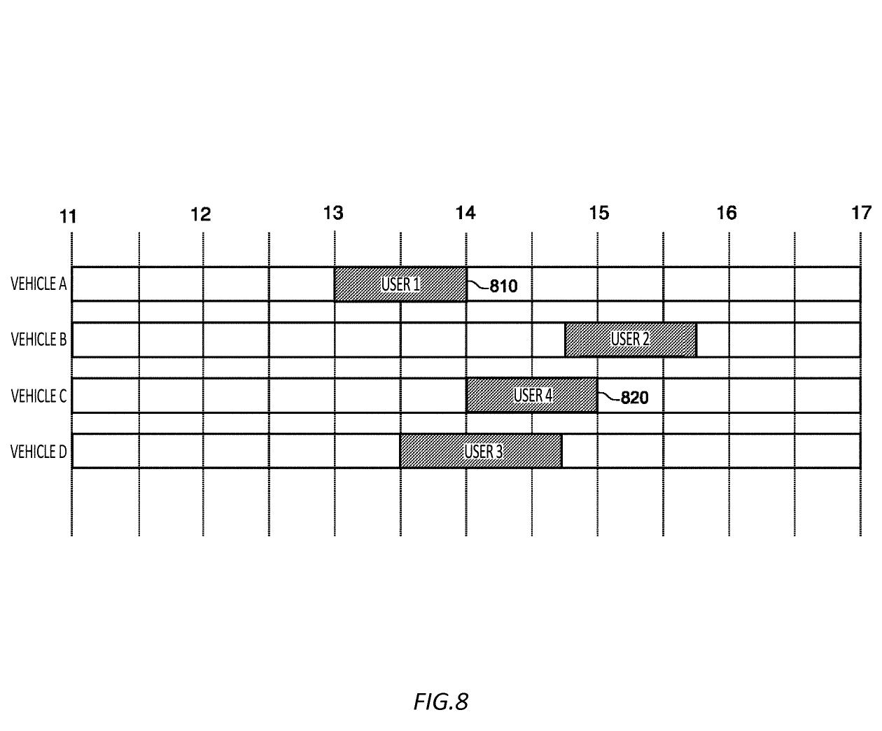

FIG. 8 schematically illustrates a timetable for using the vehicle 10 for the first use application, in which the operation plan information shown in FIG. 7 is visualized. FIG. 8 is only an illustration to facilitate describing the operation plan information. The vehicle management apparatus 60, in the first time frame, causes the first information among the operation plan information not to be presented to the user 20 through the terminal 22. The first information may be information for identifying the vehicle 10 assigned as the vehicle that is to be used by the user 20. The first information may be a time to start using and a time to end using the vehicle 10 by the user 20. The first information may be information for identifying the type of vehicle 10 assigned as the vehicle that is to be used by the user 20.

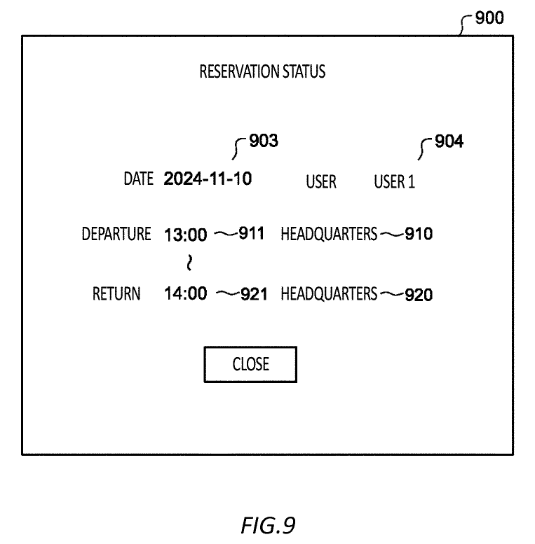

FIG. 9 illustrates a screen 900 that provides a user interface provided to the user 20. The screen 900 is an example of a first reservation screen that is presented by the terminal 22 in the first time frame when the user 20 transmits a confirmation request of the reservation status through the terminal 22. Specifically, FIG. 9 is an example of the first reservation screen that is presented by the terminal 22 in the first time frame when the user 20, who is "user 1" who allows a change of vehicle 10 to be used, transmits a confirmation request of the reservation status through the terminal 22.

The screen 900 includes information 903 indicating a date for which the vehicle 10 is reserved, information 904 indicating a user of the vehicle 10, information 910 indicating a departure point, information 911 indicating a departure time, information 920 indicating a return point, and information 921 indicating a return time.

As shown in FIG. 9, information for identifying the vehicle 10 to be used by the user 20 is, in the first time frame, restricted from being presented to the user 20 though the terminal 22. Specifically, the presentation control unit 230 of the vehicle management apparatus 60 controls, in the first time frame, the information for identifying the vehicle 10 to be used by the user 20 not to be presented to the user 20 through the terminal 22, by causing the information for identifying the vehicle 10 to be used by the user 20 not to be transmitted to the terminal 22.

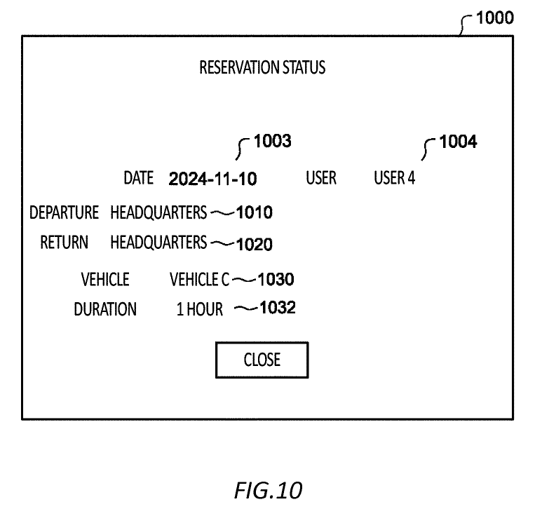

FIG. 10 illustrates a screen 1000 that provides a user interface provided to the user 20. The screen 1000 is another example of the first reservation screen that is presented by the terminal 22 in the first time frame when the user 20 transmits a confirmation request of the reservation status through the terminal 22. Specifically, FIG. 10 is an example of the first reservation screen that is presented by the terminal 22 in the first time frame when the user 20, who is "user 4" who allows a change of time to use the vehicle 10, transmits a confirmation request of the reservation status through the terminal 22.

The screen 1000 includes information 1003 indicating a date for which the vehicle 10 is reserved, information 1004 indicating a user of the vehicle 10, information 1010 indicating a departure point, information 1020 indicating a return point, information 1030 indicating a vehicle to be used, and information 1032 indicating a duration to use.

As shown in FIG. 10, information indicating a time to start using and a time to end using the vehicle 10 by the user 20 is, in the first time frame, restricted from being presented to the user 20 through the terminal 22. Specifically, the presentation control unit 230 of the vehicle management apparatus 60 controls, in the first time frame, the information indicating the time to start using and the time to end using the vehicle 10 by the user 20 not to be presented to the user 20 through the terminal 22, by causing the information indicating the time to start using and the time to end using the vehicle 10 by the user 20 not to be transmitted to the terminal 22.

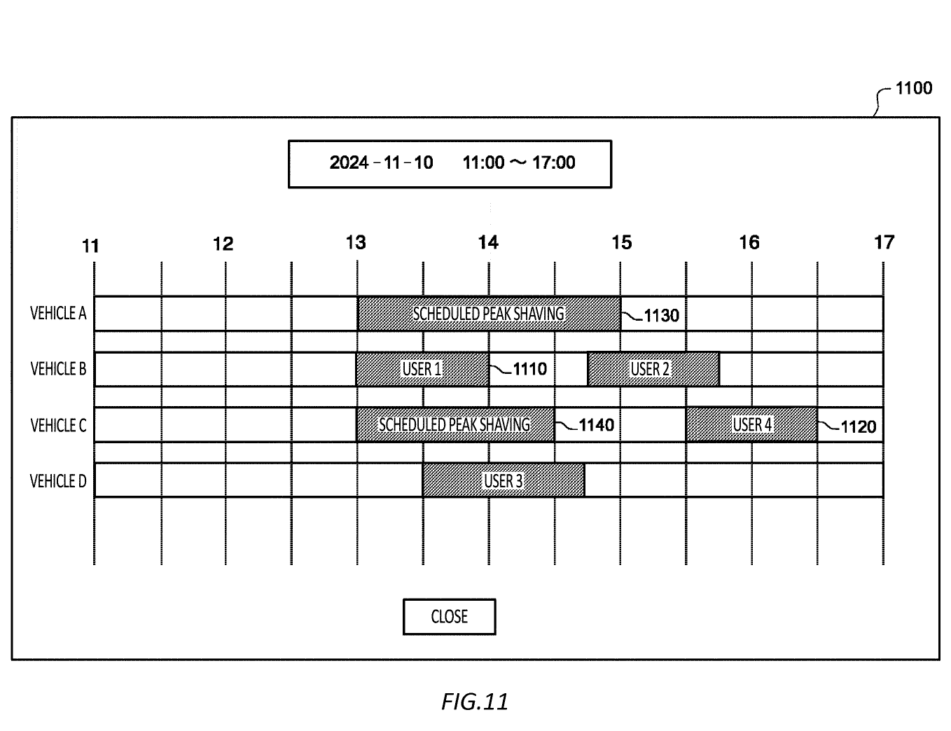

FIG. 11 illustrates a screen 1100 that provides a user interface provided to the user 20. The screen 1100 is an example of a second reservation screen that is presented by the terminal 22 in the second time frame when the user 20 transmits a confirmation request of the reservation status through the terminal 22.

The second time frame is a time frame after a time period for which the integrated management apparatus 50 performs arbitration has finished. As indicated by sign 1130 and sign 1140, the arbitration by the integrated management apparatus 50 decides that vehicle A is to be used for peak shaving of the power consumption in the office 30 for a time period from 1 p.m. to 3 p.m. (the second use application), and further that vehicle B is to be used for peak shaving of the power consumption in the office 30 for a time period from 1 p.m. to 2:30 p.m. (the second use application). As a result, as shown by sign 1110, the vehicle 10 that "user 1" uses has been changed from "vehicle A" to "vehicle B", and also as shown by sign 1120, a time period for which "user 4" uses "vehicle C" has been changed from a time period of 2 p.m. to 3 p.m. to a time period of 3:30 p.m. to 4:30 p.m.

As shown in FIG. 11, information for identifying the vehicle 10 to be used by the user 20, who is "user 1", is, in the second time frame, unlike in the first time frame, allowed to be present to the user 20 through the terminal 22. Specifically, the presentation control unit 230 of the vehicle management apparatus 60 controls, in the second time frame, the information for identifying the vehicle 10 to be used by the user 20 to be able to be presented to the user 20 through the terminal 22, by transmitting the information for identifying the vehicle 10 to be used by the user 20 to the terminal 22.

Similarly, as shown in FIG. 11, information indicating a time to start using and a time to end using the vehicle 10 by the user 20, who is "user 4", is, in the second time frame, unlike in the first time frame, allowed to be presented to the user 20 through the terminal 22. Specifically, the presentation control unit 230 of the vehicle management apparatus 60 controls, in the second time frame, the information indicating the time to start using and the time to end using the vehicle 10 by the user 20 to be able to be presented to the user 20 through the terminal 22, by transmitting the information indicating the time to start using and the time to end using the vehicle 10 by the user 20 to the terminal 22.

In FIG. 11, a use application of peak shaving is exemplified as an example of the second use application of the vehicle 10. The second use application is not limited to a use application in which the vehicle 10 is to be used for power supply to the office 30, such as peak shaving or the like. The second use application includes a use application in which the vehicle 10 is to be used for receiving electric power from the office 30. For example, the second use application includes a use application in which the vehicle 10 receives extra electric power that is predicted to be generated in the office 30 and charges it to the battery 12.

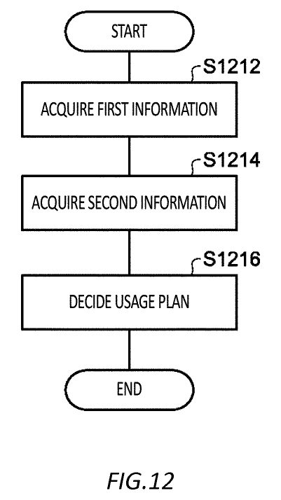

FIG. 12 illustrates a flowchart for processing to decide a usage plan of the vehicle 10, which is executed by the system 5. In S1212, first information is acquired. For example, the first acquisition unit 210 of the vehicle management apparatus 60 acquires reservation information transmitted from the terminal 22, and the first acquisition unit 310 of the integrated management apparatus 50 acquires an operation plan decided by the vehicle management apparatus 60 based on the reservation information. The reservation information acquired by the first acquisition unit 210 of the vehicle management apparatus 60 can be regarded as an example of the first information. The operation plan acquired by the first acquisition unit 310 of the integrated management apparatus 50 can be regarded as an example of the first information.

In S1214, second information is acquired. For example, the second acquisition unit 320 of the integrated management apparatus 50 acquires an electricity plan transmitted from the power control apparatus 40 as the second information.

In S1216, the usage plan of the vehicle 10 is decided. Specifically, the decision unit 340 of the integrated management apparatus 50 performs arbitration of a time period to use the vehicle 10 for the first use application and a time period to use the vehicle 10 for the second use application, based on the operation plan received from the vehicle management apparatus 60 and the electricity plan transmitted from the power control apparatus 40, and transmits a result of the arbitration to the power control apparatus 40 and the vehicle management apparatus 60. The decision unit 220 of the vehicle management apparatus 60 decide a usage plan of the vehicle 10 for the first use application by updating the operation plan based on the result of the arbitration thus received, and the power control apparatus 40 decides a usage plan of the vehicle 10 for the second use application by updating the electricity plan based on the result of the arbitration thus received.

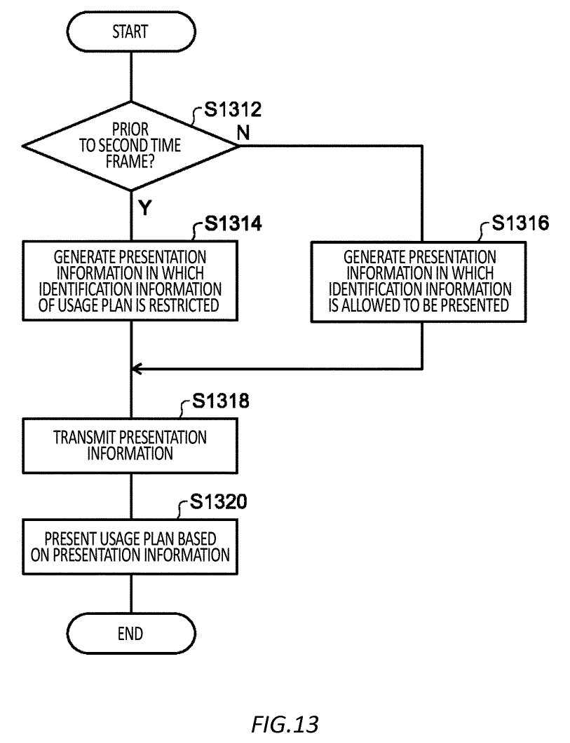

FIG. 13 illustrates a flowchart for processing to present the usage plan of the vehicle 10 to the user 20, which is executed by the system 5. The process in FIG. 13 starts when the vehicle management apparatus 60 receives a confirmation request of a reservation status transmitted from the terminal 22.

When the vehicle management apparatus 60 receives the confirmation request of the reservation status, in S1312, the presentation control unit 230 determines whether or not a current time is a time prior to the second time frame. For example, the presentation control unit 230, when the current time is a time prior to the second timing, determines that the current time is a time prior to the second time frame, or, when the current time is a time at or after the second timing, determines that the current time is not a time prior to the second time frame.

When it is determined that the current time is a time prior to the second time frame in S1312, then in S1314, the presentation control unit 230 generates presentation information in which identification information that is a part of information of the usage plan of the vehicle 10 is restricted. For example, the presentation control unit 230 generates presentation information that does not include identification information of the usage plan of the vehicle 10 by the user 20, and includes information of the usage plan of the vehicle 10 by the user 20 other than the identification information. In another embodiment, the presentation control unit 230 may generate presentation information that includes the usage plan of the vehicle 10 by the user 20 and instruction information for instructing not to present the identification information of the usage plan in question to the user 20.

When it is determined that the current time is not a time prior to the second time frame in S1312, then in S1316, the presentation control unit 230 generates presentation information in which the identification information that is a part of the information of the usage plan of the vehicle 10 is allowed to be presented. For example, the presentation control unit 230 generates presentation information that includes at least the identification information of the usage plan of the vehicle 10 by the user 20. The presentation control unit 230 may generate presentation information that includes the usage plan of the vehicle 10 by the user 20 and instruction information for instructing to allow the identification information of the usage plan in question to be presented to the user 20.

In S1318, the communication unit 290 of the vehicle management apparatus 60 transmits presentation information generated in S1314 or S1316 to the terminal 22. In S 1320, the terminal 22 presents the usage plan of the vehicle 10 to the user 20 based on the presentation information thus received. For example, the terminal 22 displays the usage plan of the vehicle 10 based on the presentation information. For example, in the first time frame, the screen 900 that does not include information for identifying the vehicle 10 is presented to the user 20, who is "user 1", as described with reference to FIG. 9, and the screen 1000 that does not include the time to start using and the time to end using the vehicle 10 is presented to the user 20, who is "user 4", as described with reference to FIG. 10. On the other hand, in the second time frame, the screen 1100 that includes information for identifying the vehicle 10 and the time to start using and the time to end using the vehicle 10 is presented, as described with reference to FIG. 11. This realizes that identification information is restricted from being presented to the user 20 in the first time frame, and that identification information is allowed to be presented to the user 20 in the second time frame.

The system 5 described above allows, in the first time frame, a usage plan that does not include information for identifying the vehicle 10 to be used by the user 20 to be presented to the user 20 for whom the vehicle 10 to be used may be changed. Further, in the first time frame, an operation plan that does not include information for identifying the time period for which the user 20 is to use the vehicle 10 can be presented to the user 20 for whom the time period to use the vehicle 10 may be changed. On the other hand, since a usage plan that includes information for identifying the vehicle 10 to be used by the user 20 and information for identifying the time period for which the user 20 is to use the vehicle 10 can be presented in the second time frame, convenience for the user 20 can be improved.

In the above description, the embodiment is described in which the vehicle management apparatus 60 and the integrated management apparatus 50 cooperate to implement functions as an information processing apparatus that performs information processing for a usage plan of a reservation target. However, as another embodiment, an embodiment may be employed in which functions of the vehicle management apparatus 60 and the integrated management apparatus 50 are implemented by one information processing apparatus.

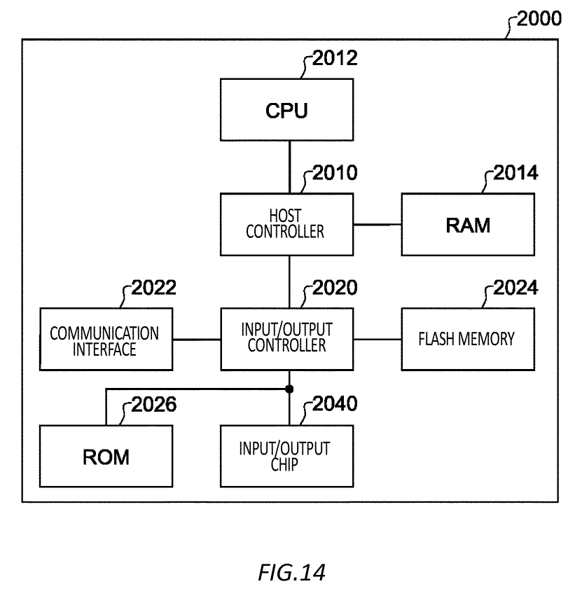

FIG. 14 shows an example of a computer 2000 in which a plurality of embodiments of the present invention may be entirely or partially embodied. A program installed on the computer 2000 may cause the computer 2000 to: function as the system 5 or each unit of the system 5 according to an embodiment, or an apparatus such as the power control apparatus 40, the integrated management apparatus 50, or the vehicle management apparatus 60 or each unit of the apparatus; or perform an operation associated with the system or each unit of the system, or the apparatus or each unit of the apparatus; and/or perform a process or a step of the process according to an embodiment. Such a program may be executed by a CPU 2012 in order to cause the computer 2000 to execute a specific operation associated with some or all of the processing procedures and the blocks in the block diagrams described in the present specification.

The computer 2000, according to the present embodiment, includes the CPU 2012 and a RAM 2014, which are mutually connected by a host controller 2010. The computer 2000 also includes a ROM 2026, a flash memory 2024, a communication interface 2022, and an input/output chip 2040. The ROM 2026, the flash memory 2024, the communication interface 2022, and the input/output chip 2040 are connected to the host controller 2010 via an input/output controller 2020.

The CPU 2012 operates in accordance with programs stored in the ROM 2026 and the RAM 2014, and thereby controls each unit.

The communication interface 2022 communicates with another electronic device via a network. The flash memory 2024 stores a program and data used by the CPU 2012 in the computer 2000. The ROM 2026 stores a boot program or the like executed by the computer 2000 upon activation, and/or a program that depends on hardware of the computer 2000. The input/output chip 2040 may also connect various input/output units such as a keyboard, a mouse, and a monitor, to the input/output controller 2020 via input/output ports such as a serial port, a parallel port, a keyboard port, a mouse port, a monitor port, a USB port, an HDMI (registered trademark) port.

A program is provided via a network or a computer-readable storage medium such as a CD-ROM, a DVD-ROM, or a memory card. The RAM 2014, the ROM 2026, or the flash memory 2024 is an example of a computer-readable storage medium. The program is installed in the flash memory 2024, the RAM 2014, or the ROM 2026, and executed by the CPU 2012. Information processing written in these programs is read by the computer 2000, and provides cooperation between the programs and the various types of hardware resources described above. An apparatus or a method may be constructed by realizing operations or processing of information in accordance with a use of the computer 2000.

For example, when a communication is executed between the computer 2000 and an external device, the CPU 2012 may execute a communication program loaded on the RAM 2014, and instruct the communication interface 2022 to execute communication processing based on processing described in the communication program. Under the control of the CPU 2012, the communication interface 2022 reads transmission data stored in a transmission buffer processing region provided in a recording medium such as the RAM 2014 or the flash memory 2024, transmits the read transmission data to the network, and writes reception data received from the network into a reception buffer processing region or the like provided on the recording medium.

In addition, the CPU 2012 may cause all or a necessary portion of a file or a database stored in a recording medium such as the flash memory 2024 and the like to be read into the RAM 2014, and execute various types of processing on the data in the RAM 2014. Next, the CPU 2012 writes back the processed data into the recording medium.

Various types of information, such as various types of programs, data, a table, and a database, may be stored in the recording medium and may be subjected to information processing. The CPU 2012 may execute, on the data read from the RAM 2014, various types of processing, including various types of operations, information processing, conditional judgement, conditional branching, unconditional branching, information search/replacement, or the like described in the present specification and designated by instruction sequences of the programs, and write back a result into the RAM 2014. In addition, the CPU 2012 may search for information in a file, a database, or the like in the recording medium. For example, when a plurality of entries each having an attribute value of a first attribute associated with an attribute value of a second attribute, is stored in the recording medium, the CPU 2012 may search for an entry having a designated attribute value of the first attribute that matches a condition from said plurality of entries, and read the attribute value of the second attribute stored in said entry, thereby obtaining the attribute value of the second attribute associated with the first attribute that satisfies a predefined condition.

The program or software module described above may be stored in a computer-readable storage medium on the computer 2000 or near the computer 2000. A recording medium, such as a hard disk or a RAM provided in a server system connected to a dedicated communication network or the Internet, can be used as the computer-readable storage medium. A program stored in the computer-readable storage medium may be provided to the computer 2000 via a network.

Programs that are installed in the computer 2000 and cause the computer 2000 to function as the integrated management apparatus 50 may cause, when executed by the computer, the computer 2000 to function as each unit of the integrated management apparatus 50 by working with the CPU 2012 or the like. The information processing described in these programs is read by the computer 2000, and the computer 2000 functions as each unit of the integrated management apparatus 50 which is a specific means in which software and the above-described various hardware resources cooperate. Then, when a computation or processing of information according to the intended use of the computer 2000 in the present embodiment is realized by these specific means, the unique integrated management apparatus 50 according to the intended use is constructed.

The program installed in the computer 2000 to cause the computer 2000 to function as the vehicle management apparatus 60 may work on the CPU 2012 or the like to cause the computer 2000 to function as each unit of the vehicle management apparatus 60. The information processing described in these programs is read by the computer 2000 to function as each unit of the vehicle management apparatus 60 which is a specific means in which software and the above-described various hardware resources cooperate. Then, when computation or processing of information according to the intended use of the computer 2000 in the present embodiment is realized by these specific means, the unique vehicle management apparatus 60 according to the intended use is constructed.

Various embodiments have been described with reference to the block diagrams and the like. In the block diagrams, each block may represent (1) a step of a process in which an operation is executed, or (2) each part of the device having a role in executing the operation. A particular step and each part may be implemented by a dedicated circuit, a programmable circuit supplied with computer-readable instructions stored on a computer-readable storage medium, and/or a processor supplied with computer-readable instructions stored on a computer-readable storage medium. The dedicated circuit may include a digital and/or analog hardware circuit, or may include an integrated circuit (IC) and/or a discrete circuit. The programmable circuit may include a reconfigurable hardware circuit including logical AND, logical OR, logical XOR, logical NAND, logical NOR, and another logical operation, and a memory element or the like, such as a flip-flop, a register, a field-programmable gate array (FPGA), a programmable logic array (PLA), or the like.

The computer-readable storage medium may include any tangible device capable of storing instructions to be executed by an appropriate device, so that the computer-readable storage medium having instructions stored therein constitutes at least a part of a product including instructions which can be executed to provide means for executing processing procedures or operations designated in the block diagrams. An example of the computer-readable storage medium may include an electronic storage medium, a magnetic storage medium, an optical storage medium, an electromagnetic storage medium, a semiconductor storage medium, etc. A more specific example of the computer-readable storage medium may include a FLOPPY (registered trademark) disk, a diskette, a hard disk, a random access memory (RAM), a read-only memory (ROM), an erasable programmable read-only memory (EPROM or flash memory), an electrically erasable programmable read-only memory (EEPROM), a static random access memory (SRAM), a compact disc read-only memory (CD-ROM), a digital versatile disk (DVD), a BLU-RAY (registered trademark) disk, a memory stick, an integrated circuit card, or the like.

The computer-readable instructions may include an assembler instruction, an instruction-set-architecture (ISA) instruction, a machine instruction, a machine-dependent instruction, a microcode, a firmware instruction, state-setting data, or either of source code or object code written in any combination of one or more programming languages including an object oriented programming language such as SMALLTALK (registered trademark), JAVA (registered trademark), and C++, or the like, and a conventional procedural programming language such as a "C" programming language or a similar programming language.

The computer-readable instruction is provided to the processor or programmable circuit of programmable data processing apparatuses, such as a computer locally or via a local area network (LAN), a wide area network (WAN) such as the Internet, and the computer-readable instruction may be executed in order to provide means to execute the operations specified in the described processing procedure or block diagrams.

Here, the computer may be a computer such as a personal computer (PC), a tablet computer, a smartphone, a workstation, a server computer, or a general-purpose computer, or may be a computer system in which a plurality of computers are connected. Such a computer system in which a plurality of computers are connected is also referred to as a distributed computing system, and is a computer in a broad sense. In a distributed computing system, a plurality of computers collectively execute a program by each of the plurality of computers executing a portion of the program, and passing data during the execution of the program among the computers as needed.

Examples of the processor include a computer processor, a central processing unit (CPU), a processing unit, a microprocessor, a digital signal processor, a controller, a microcontroller, and the like. The computer may include one processor or a plurality of processors. In a multi-processor system including a plurality of processors, the plurality of processors collectively execute a program by each of the processors executing a portion of the program, and passing data during the execution of the program among the processors as needed. For example, in execution of multitasking, each of the plurality of processors may execute a portion of each task piece by piece by performing task-switching for each time slice. In this case, which portion of one program each processor is responsible for executing dynamically changes. In addition, which portion of the program each of the plurality of processors is to execute may be statically defined by multiprocessor-aware programming.

While the present invention has been described by way of the embodiments, the technical scope of the present invention is not limited to the above-described embodiments. It is apparent to persons skilled in the art that various modifications or improvements can be made to the above-described embodiments. It is also apparent from the description of the claims that the embodiments to which such modifications or improvements are made may be included in the technical scope of the present invention.

Note that the operations, procedures, steps, and stages etc. of each process performed by a device, system, program, and method shown in the claims, specification, or diagrams can be executed in any order as long as the order is not indicated by "before", "prior to", or the like and as long as the output from a previous process is not used in a later process. Even if the operation flow is described using phrases such as "first" or "next" for the sake of convenience in the claims, specification, or drawings, it does not necessarily mean that the process must be performed in this order.

### EXPLANATION OF REFERENCES

5: system;

10: vehicle;

12: battery;

20: user;

22: terminal;

30, 31: office;

40, 41: power control apparatus;

50, 51: integrated management apparatus;

60, 61: vehicle management apparatus;

70: power consumer;

80: power generation apparatus;

90: power network;

140: power control apparatus;

180: server;

190: communication network;

200: computation unit;

210: first acquisition unit;

220: decision unit;

230: presentation control unit;

280: storage unit;

290: communication unit;

300: computation unit;

310: first acquisition unit;

320: second acquisition unit;

340: decision unit;

380: storage unit;

390: communication unit;

600, 900, 1000, 1100: screen;

603: input box;

604, 606, 607, 608, 609, 610, 612, 620, 650: selection menu;

611, 621: input box;

616, 618: button;

680: register button;

903, 904, 910, 911, 920, 921, 1003, 1004, 1010, 1020, 1030, 1032: information;

1110, 1120, 1130, 1140: sign;

2000: computer;

2010: host controller;

2012: CPU;

2014: RAM;

2020: input/output controller;

2022: communication interface;

2024: flash memory;

2026: ROM;

2040 input/output chip.

What is claimed is:

1. An information processing apparatus which performs information processing for a usage plan of a reservation target, comprising:
a first acquisition unit which acquires first information which includes a first time period for which a reservation target is scheduled to be used for a first use application;
a second acquisition unit which acquires second information which includes a second time period for which a reservation target is scheduled to be used for a second use application;
a decision unit which decides the usage plan based on the first information and the second information; and
a presentation control unit which, in a first time frame, restricts a presentation unit which presents information on the usage plan from presenting identification information that is a portion of the usage plan, and, in a second time frame after the first time frame, allows the presentation unit to present the identification information.

2. The information processing apparatus according to claim 1, wherein
the reservation target is a vehicle which includes an energy accumulation apparatus, and
the second use application is a use application for which the vehicle is to be used for energy exchange between the vehicle and an energy network which is capable of energy exchange.

3. The information processing apparatus according to claim 2, wherein
the first use application is a use application which involves traveling of the vehicle.

4. The information processing apparatus according to claim 1, wherein
the first information further includes designation information which designates a specific reservation target which is to be used for the first use application, among a plurality of reservation targets.

5. The information processing apparatus according to claim 4, wherein
the first information further includes information on a degree of importance of the designation information.

6. The information processing apparatus according to claim 1, wherein
the first information further includes information on a degree of importance of the first time period.

7. The information processing apparatus according to claim 1, wherein
the identification information includes information for identifying a reservation target which is to be used for the first use application in the usage plan.

8. The information processing apparatus according to claim 7, wherein
the presentation control unit, in the first time frame, allows the presentation unit to present a time at or a time frame for which a reservation target is to be used for the first use application in the usage plan.

9. The information processing apparatus according to claim 1, wherein
the identification information includes information for identifying a time at or a time frame for which a reservation target is to be used for the first use application in the usage plan.

10. The information processing apparatus according to claim 9, wherein
the presentation control unit, in the first time frame, allows the presentation unit to present information for identifying a reservation target which is to be used for the first use application in the usage plan.

11. The information processing apparatus according to claim 1, wherein
the first time frame includes a time frame prior to a timing at which the second acquisition unit acquires the second information, and
the second time frame includes a time frame after the second acquisition unit acquires the second information.

12. The information processing apparatus according to claim 2, wherein
the first information further includes designation information which designates a specific reservation target which is to be used for the first use application, among a plurality of reservation targets.

13. The information processing apparatus according to claim 3, wherein
the first information further includes designation information which designates a specific reservation target which is to be used for the first use application, among a plurality of reservation targets.

14. The information processing apparatus according to claim 2, wherein
the first information further includes information on a degree of importance of the first time period.

15. The information processing apparatus according to claim 3, wherein
the first information further includes information on a degree of importance of the first time period.

16. The information processing apparatus according to claim 2, wherein
the identification information includes information for identifying a reservation target which is to be used for the first use application in the usage plan.

17. The information processing apparatus according to claim 3, wherein
the identification information includes information for identifying a reservation target which is to be used for the first use application in the usage plan.

18. The information processing apparatus according to claim 2, wherein
the identification information includes information for identifying a time at or a time frame for which a reservation target is to be used for the first use application in the usage plan.

19. An information processing method for performing information processing for a usage plan of a reservation target, comprising:
acquiring first information which includes a first time period for which a reservation target is scheduled to be used for a first use application;
acquiring second information which includes a second time period for which a reservation target is scheduled to be used for a second use application;
deciding the usage plan based on the first information and the second information; and
in a first time frame, restricting a presentation unit which presents information on the usage plan from presenting identification information that is a portion of the usage plan, and, in a second time frame after the first time frame, allowing the presentation unit to present the identification information.

20. A computer-readable storage medium having recorded thereon a program for information processing for a usage plan of a reservation target, the program, when executed by a computer, causing the computer to function as:
a first acquisition unit which acquires first information which includes a first time period for which a reservation target is scheduled to be used for a first use application;
a second acquisition unit which acquires second information which includes a second time period for which a reservation target is scheduled to be used for a second use application;
a decision unit which decides the usage plan based on the first information and the second information; and
a presentation control unit which, in a first time frame, restricts a presentation unit which presents information on the usage plan from presenting identification information that is a portion of the usage plan, and, in a second time frame after the first time frame, allows the presentation unit to present the identification information.
